(19) United States
(12) Patent Application Publication
(10) Pub. No.: US 2012/0255992 A1
(43) Pub. Date: Oct. 11, 2012

(54) Flux preparation with increased dynamic viscosity containing dehydrated K2A1F5, method to produce it and method to use it

(75) Inventor: Alfred Ottmann, Hannover (DE)

(73) Assignee: SOLVAY FLUOR GMBH, Hannover (DE)

(21) Appl. No.: 13/516,840

(22) PCT Filed: Dec. 16, 2010
(86) PCT No.: PCT/EP2010/069994

§ 371 Date: Jun. 18, 2012

(30) Foreign Application Priority Data
Dec. 21, 2009 (EP) 09180229.8

(51) Int. Cl. B23K 35/363; B23K 1/00

(52) U.S. Cl. 228/256; 148/26; 148/23

(57) ABSTRACT

Aqueous flux preparations with increased dynamic viscosity are provided. In the flux preparations, irreversibly dehydrated K₂AlF₅ (also denoted as orthorhombic K₂AlF₅ or phase II salt) provides for an increase of the dynamic viscosity if the aqueous flux preparations are aged, i.e., a contact between water comprised in the preparation and irreversibly dehydrated K₂AlF₅ is maintained for a certain time span, preferably for at least 12 minutes. The higher viscosity improves the brazing process, for example because less flux preparation drops off from the parts to be brazed.

### CROSS-REFERENCE TO RELATED APPLICATIONS

The present application is a U.S. national stage entry under 35 U.S.C. §371 of International Application No. PCT/EP2010/069994 filed Dec. 16, 2010, which claims priority to European Application No. 09180229.8 filed on Dec. 21, 2009, the whole content of this application being incorporated herein by reference for all purposes.

### TECHNICAL FIELD OF THE INVENTION

The present invention relates to an aqueous flux preparation with increased dynamic viscosity. The present invention also relates to a flux composition which provides an aqueous flux preparation with increased dynamic viscosity and which can be used to prepare the aqueous flux preparation. The present invention also relates to a method for increasing the viscosity of an aqueous flux preparation and to a process for brazing using the aqueous flux preparation.

### BACKGROUND

It is well known in the art that the brazing of aluminum parts with one another or the brazing of aluminum parts with parts of copper, steel or titanium can be performed utilizing a lot of different fluxes. A flux very suitable for the brazing of aluminum parts to parts made from aluminum, copper, steel or titanium is based on alkali metal fluoroaluminates.

Several methods are known to apply the flux on the surface of the parts to be brazed.

According to one method, the flux is applied in dry form by means of electrostatic forces.

According to another method, the flux is applied in wet form to the surface or surfaces. Here, the flux is dispersed in water, organic solvents or mixtures thereof and applied for example by spraying, painting, printing or by immersing the parts into a respective flux preparation.

Flux preparations consisting simply of flux and solvent have the disadvantage that a part of the flux preparation does not adhere to the surface. Either this part is lost as waste, or it must be recycled.

Consequently, in wet applications, binders, for example, polyacrylate or polyurethane, can be applied to improve the adhesion, and thickeners, for example pectines, gelatine or polyurethane, can be applied to reduce the dropping off of the preparation from the parts to be brazed. Both binder and thickener are often organic compounds, and thus, the wet flux preparation contains organic matter which has to be removed prior to the brazing process to minimize carbon contamination.

### SUMMARY OF THE INVENTION

Objective of the present invention is to provide a flux preparation with improved viscosity and sedimentation behavior. Another objective of the present invention is to provide a flux composition which can be processed to a flux preparation with improved viscosity and sedimentation behavior.

These objectives and other objectives are achieved by the present invention.

One aspect of the present invention concerns an aqueous flux preparation, which is aged and which comprises irreversibly dehydrated K₂AlF₅. Consequently, the aged flux preparation also contains water.

### DETAILED DESCRIPTION

The term “irreversibly dehydrated K₂AlF₅” denotes dipotassium pentafluoroaluminate or a dipotassium pentafluoroaluminate hydrate which was heated such that it loses the capability to rehydrate when brought again into contact with water. A detailed description of such an irreversibly dehydrated K₂AlF₅ and how to obtain it is described in U.S. Pat. No. 5,980,650 the whole content of which is incorporated herein by reference for all purposes. It is well known that K₂AlF₅ and its hydrate, especially K₂AlF₅.H₂O, usually are manufactured from aluminum oxide, aqueous KOH and HF in respective molar ratios. K₂AlF₅ and its hydrate are sparely soluble in water and precipitate. The precipitated product is dried, and it was observed that up to certain elevated temperatures, water and crystal water of the precipitated K₂AlF₅ and its hydrate evaporate. K₂AlF₅ is formed which is anhydrous, but retains the capability to rehydrate when it is contacted with water, i.e., it forms K₂AlF₅ hydrate. K₂AlF₅ which can be rehydrated was denoted as “phase I” salt; it crystallizes in the tetragonal system. It was found that reversibly dehydrated K₂AlF₅ is formed at a temperature above about 90° C. Above a certain temperature, the phase I salt starts to form a salt denoted “phase II salt” having another crystallographic system, the orthorhombic system. The change of the crystallographic system appears to start at a temperature of about 228° C. under quasi-isobaric conditions and in any case at about 265±10° C. Further details are given below. Thus, the term “irreversibly dehydrated K₂AlF₅” denotes the same compound as the terms “phase II salt” or “orthorhombic K₂AlF₅”, and the terms are used interchangeably.

The contact between water comprised in the preparation and irreversibly dehydrated K₂AlF₅ is maintained for a certain time span (e.g., 4 minutes or more, and preferably, 12 minutes or more, see below) during which the preparation “ages” and forms an “aged” preparation. The term “aged” denotes a time span which starts with the first contact between water and irreversibly dehydrated K₂AlF₅. It was observed by the inventors that irreversibly dehydrated K₂AlF₅, when brought into contact with water or mixtures of water and organic liquids such as alcohols, ketones or other organic liquids and optionally additives as explained below, for a certain time span, forms an aqueous preparation which undergoes a change in its dynamic viscosity: the dynamic viscosity increases.

This change of properties, notably the increase in dynamic viscosity of the aqueous preparation comprising irreversibly dehydrated K₂AlF₅, is denoted as “aging”, and the aqueous preparation, having an increased dynamic viscosity after a time span of first contact of water and phase II salt, compared to the initial dynamic viscosity of the preparation when irreversibly dehydrated K₂AlF₅, or expressed in other terms, namely phase II salt or orthorhombic K₂AlF₅, and water or mixture of water and organic liquid are initially contacted, is called “aged”. Thus, the aged aqueous flux preparation comprises water and irreversibly dehydrated K₂AlF₅, and the contact between water and the irreversibly dehydrated K₂AlF₅ is maintained for an effective time span such that the dynamic viscosity of the preparation in the moment of the first contact between water and irreversibly dehydrated K₂AlF₅ increases during the effective time span and the aged aqueous flux preparation forms.

A preferred aged preparation has a dynamic viscosity which is at least 10% higher than the dynamic viscosity of the composition at the moment when phase II salt or a flux composition comprising the phase II salt is contacted with water or aqueous compositions.

In a first embodiment, the aged aqueous flux preparation comprises water and irreversibly dehydrated K₂AlF₅, and the contact between water and the irreversibly dehydrated K₂AlF₅ is maintained for equal to or more than 4 minutes. During these 4 minutes, the aqueous flux preparation ages, and the dynamic viscosity of the preparation in the moment of the first contact between water and irreversibly dehydrated K₂AlF₅ increases during the contact of equal to or more than 4 minutes. Often, the dynamic viscosity is sufficiently high even after an aging time of less than 12 minutes. An aging time of equal to or less than 3 days is preferred; but the aging time can be expanded even beyond 3 days if desired. Thus, in this embodiment, the aging time is preferably equal to or longer than 4 minutes, and equal to or shorter than 3 days, preferably, shorter than 12 minutes. The flux preparation generally contains at least 0.5% by weight of irreversibly dehydrated K₂AlF₅.

According to a second embodiment, the flux preparation is aged for at least 12 minutes, i.e., it is aged for equal to or more than 12 minutes, and contains generally at least 0.5% by weight of irreversibly dehydrated K₂AlF₅. This second embodiment is preferred and will be explained in detail below. The definitions for terms, for example, the terms “aged”, “irreversibly dehydrated K₂AlF₅” or “aging time” apply for both embodiments.

According to a second embodiment, the flux preparation is aged for at least 12 minutes, i.e., the contact between water and phase II salt is maintained for equal to or more than 12 minutes. The flux preparation in this embodiment contains generally at least 0.5% by weight of irreversibly dehydrated K₂AlF₅. An aging time of equal to or less than 3 days is preferred in this embodiment; but the aging time can be expanded even beyond 3 days if desired. Thus, in this embodiment, the aging time is preferably equal to or longer than 12 minutes, and equal to or shorter than 3 days. The flux preparation generally contains at least 0.5% by weight of irreversibly dehydrated K₂AlF₅. This second embodiment is preferred and will be explained in detail below. The definitions for terms, for example, the terms “aged”, “irreversibly dehydrated K₂AlF₅” or “aging time” apply for both embodiments.

In some embodiment of the method for the manufacture of the flux preparation comprising water and irreversibly dehydrated K₂AlF₅, a carrier liquid consisting of water or comprising water and irreversibly dehydrated K₂AlF₅, and optionally a basic flux, binder, thickener and additives are mixed, and a contact time of equal to or more than 12 minutes between water and irreversibly dehydrated K₂AlF₅ is provided to allow an aging of the flux preparation.

As mentioned, the composition is aged in this second embodiment for at least 12 minutes; this means that a contact time, or in other words, an aging time of at least 12 minutes has passed from the moment of contacting water or aqueous composition and phase II salt or a flux composition comprising the phase II salt. The term “aging time”, or expressed in other words, “contact time”, means the time span of contact between water and phase II salt. “Aged for at least 12 minutes” means that from the first contact of water and phase II salt, at least 12 minutes have passed. Such a flux preparation has a dynamic viscosity, measured at 20° C., at a shear-rate of 1000 s⁻¹, with a Rheolab MC1 apparatus, measuring system MP31 (50 mm, 0°); the gap width d=0.500 mm which is at least 20% higher than the dynamic viscosity of a corresponding aqueous flux preparation comprising no irreversibly dehydrated K₂AlF₅. The shear-rate is measured as speed, divided by gap-size in mm·s⁻¹·mm⁻¹. Preferred aqueous flux preparations are those aged for at least 60 minutes. They have a dynamic viscosity, measured at 20° C. at a shear-rate of 1000 s⁻¹, with a Rheolab MC1 apparatus, measuring system MP31 (50 mm, 0°); the gap width d=0.500 mm a which is at least 50% higher than the dynamic viscosity of a corresponding flux preparation comprising no irreversibly dehydrated K₂AlF₅. Still more preferred aqueous flux preparations are those aged for at least 120 minutes. They have a dynamic viscosity, measured at 20° C. as above, which is at least 50% higher than the dynamic viscosity of a corresponding flux preparation comprising no irreversibly dehydrated K₂AlF₅. Consequently, the flux preparations of the present invention are generally aged for at least 12 minutes before they are used for brazing; this can be achieved by contacting water or a mixture of water and an organic liquid, e.g., an monohydroxy alcohol or a polyhydroxy alcohol, a ketone, and the phase II salt or a respective flux composition, preferably under mixing, and maintaining the contact for equal to or more than 12 minutes, for example, in a mixer or in a storage tank. Thus, often the aging time is the time span starting with first contact of water or an aqueous composition with the phase II salt or the flux composition comprising the phase II salt, and the application of the aged composition for brazing, i.e., its application to the metal parts (especially aluminum or aluminum alloys) and the heating of the parts during the brazing process. The increase of viscosity was observed when the samples were aged at ambient temperature (about 20° C.). It is assumed that aging time can be shorter if the samples are aged at a higher temperature, e.g., between 30 and 60° C.

The content of irreversibly dehydrated K₂AlF₅ in the aged aqueous flux preparations is preferably equal to or greater than 1% by weight of the total preparation. The content of irreversibly dehydrated K₂AlF₅ in the aged aqueous flux preparations is preferably equal to or lower than 30% by weight of the total aqueous flux preparation. More preferably, it is equal to or lower than 20% by weight. For the sake of simplicity, the term “irreversibly dehydrated K₂AlF₅” will be denoted often as “phase II salt” in this specification.

The flux composition comprised in the flux preparation and the preferred embodiments corresponds to the flux composition described above.

According to one embodiment, the flux preparation contains only irreversibly dehydrated K₂AlF₅, as flux component.

According to a preferred embodiment, the flux preparation comprises, additionally to the irreversibly dehydrated K₂AlF₅, at least one further flux suitable for brazing of parts of aluminum or aluminum alloys to parts of aluminum, aluminum alloys, steel, copper or titanium. To distinguish this further flux from the irreversibly dehydrated K₂AlF₅, this additional flux will be denoted as “basic flux”. In the context of the present invention, the term “basic” in “basic flux” is used with the meaning of “fundamental”, not in the meaning of “chemical base=having a pH value lower than 7”. Thus, the term “The flux preparation which comprises at least one basic flux selected from the group consisting of KAlF₄, K₂AlF₅, KAlF₅.H₂O, CsAlF₄, Cs₂AlF₅, Cs₃AlF₆, potassium fluorozincate, cesium fluorozincate, potassium fluorostannate, and cesium fluorostannate” has the same meaning as “The flux preparation which comprises at least one fundamental flux selected from the group consisting of KAlF₄, K₂AlF₅, KAlF₅.H₂O, CsAlF₄, Cs₂AlF₅, Cs₃AlF₆, potassium fluorozincate, cesium fluorozincate, potassium fluorostannate, and cesium fluorostannate”.

As mentioned above, the flux preparation is an aqueous preparation. Consequently, it contains a carrier which is constituted from water or from mixtures of water and an organic liquid.

According to one embodiment, the carrier of the flux preparation is water. De-ionized water, distilled water or tap water is suitable as carrier.

According to another embodiment, the aqueous carrier comprises water and an organic liquid which preferably is miscible with water. Preferably, in this embodiment, the content of water in the carrier is equal to or greater than 10% by weight, more preferably, equal to or greater than 25% by weight. The organic liquid is preferably selected from the group consisting of alcohols and ketones. In this embodiment, ethanol, n-propanol, isopropanol, glycols, e.g., ethylene glycol, propylene glycol and diethylene glycol are preferred alcohols, and acetone is the preferred ketone. The aqueous carrier may comprise other organic constituents, for example, binders or thickeners.

The aqueous carrier preferably consists of water.

Of course, also in this case, the water may contain certain amounts of organic constituents, e.g., dispersed or dissolved binder or thickener.

The flux preparation according to the invention will now be described in further detail in view of the preferred alternative wherein water, and no organic liquid, such as an alcohol or ketone, is present as carrier.

In the flux preparation with water as carrier, the content of the phase II salt, the basic flux and any additives, if present, is preferably equal to or greater than 10% by weight. For the sake of simplicity, the content of phase II salt, any basic flux and any additives which facilitate the brazing process, e.g., brazing alloy or brazing alloy precursor, or which improve the properties of the brazed parts, e.g., LiF or Li₃AlF₆, are often denoted as “flux composition” in the following. More preferably, the content of the flux composition is equal to or greater than 20% by weight. Preferably, the content of the flux composition in the flux preparation is equal to or less than 50% by weight. The content of irreversibly dehydrated K₂AlF₅ is, as indicated above, preferably equal to or greater than 0.5% by weight of the total flux preparation. More preferably, the content of irreversibly dehydrated K₂AlF₅ is equal to or greater than 1% by weight of the total flux preparation. Preferably, the content of irreversibly dehydrated K₂AlF₅ is equal to or lower than 50% by weight of the total flux preparation. More preferably, the content of irreversibly dehydrated K₂AlF₅ is equal to or lower than 30% by weight of the total flux preparation.

The aqueous flux preparation optionally contains additives which facilitate the brazing process or improve the brazed parts. For example, the additives mentioned above which facilitate the brazing process or the properties of the brazed parts can be present in the flux preparation. For example, the flux preparation may contain brazing alloy or Si powder, preferably in an amount of from 2 to 20% by weight, if present, LiF or Li₃AlF₆ in an amount of from 0.5 to 15% by weight, if present, of the total flux preparation set to 100% by weight. Water and, if present, other additives, for example, binder, thickener or surfactants are the balance to 100% by weight.

Preferably, the irreversibly dehydrated K₂AlF₅, any basic flux and additives if present are dispersed in the aqueous carrier.

In one embodiment of the present invention, the flux preparation contains the flux composition, water and optionally additives which facilitate the brazing process or improve the brazed parts, but no binder and no thickener. The amount of flux composition and, if present, said additives, correspond to the amounts given above.

In another embodiment of the present invention, the flux preparation comprises the flux composition, water, binder and optionally additives which facilitate the brazing process or improve the brazed parts. The amount of the flux composition in this flux preparation is preferably equal to or greater than 10% by weight, when the total weight of the flux preparation including the flux composition, carrier and additives is set to 100% by weight (“total weight of the flux preparation”). More preferably, it is equal to or greater than 20% by weight. Especially preferably, it is equal to or greater than 25% by weight.

Preferably, the content of the flux composition in the flux preparation is equal to or less than 50% by weight. Also in this embodiment, the content of irreversibly dehydrated K₂AlF₅ is preferably equal to or greater than 0.5% by weight of the flux preparation. More preferably, the content of irreversibly dehydrated K₂AlF₅ is equal to or greater than 1% by weight of the flux preparation. Preferably, the content of irreversibly dehydrated K₂AlF₅ is equal to or lower than 30% by weight of the flux preparation. More preferably, the content of irreversibly dehydrated K₂AlF₅ is equal to or lower than 20% by weight of the flux preparation. If present, brazing alloy, especially aluminum-silicon alloy, or brazing alloy precursor, especially Si powder, is contained in amount of, preferably, from 2 to 20% by weight, and the amount of LiF or Li₃AlF₆, if present, is preferably from 0.5 to 15% by weight. The percentages refer to the total weight of the flux preparation. In this embodiment, no organic thickener is contained.

Suitable binders are known to the man skilled in the art. Preferred binders are selected from the group consisting of organic polymers. Such polymers are physically drying (i.e., they form a solid coating after the liquid is removed), or they are chemically drying (they may form a solid coating e.g., under the influence of chemicals, e.g., oxygen or light which causes a cross linking of the molecules), or both. Preferred organic polymers are selected from the group consisting of polyolefins, e.g., butyl rubbers, polyurethanes, resins, phthalates, polyacrylates, polymethacrylates, vinyl resins, epoxy resins, nitrocellulose, polyvinyl acetates and polyvinyl alcohols. The binder can be water-soluble or water-insoluble. The amount of binder in the flux preparation is preferably equal to or greater than 1% by weight, more preferably, equal to or greater than 5% by weight, of the total flux preparation. Especially preferably, it is equal to or greater than 10% by weight. Preferably, the amount of binder is equal to or lower than 30% by weight, more preferably, equal to or lower than 20% by weight, of the total flux preparation.

Polyacrylates, polymethacrylates, polyvinyl alcohols and polyurethanes are preferred binders in the present invention.

In still another embodiment of the present invention, the flux preparation comprises the flux composition, water, a binder, a thickener and optionally additives which facilitate the brazing process or improve the brazed parts. The thickener may also provide the flux preparation with thixotropic properties. A wax as described in EP-A 1808264, methyl butyl ether, gelatin, pectin, acrylates or polyurethane, as described in EP-A-1 287941, are preferred thickeners.

In this embodiment, the thickener is preferably present in an amount equal to or greater than 1% by weight of the total flux preparation; the thickener is preferably present in an amount equal to or lower than 10% by weight. The presence of the thickener is especially advantageous if the content of irreversibly dehydrated K₂AlF₅ is in the lower range, e.g., in a range of from 5 to 20% by weight of the total flux preparation. A thickener can be technically advantageous even with higher amounts of the phase II salt; but since for ecological and safety reasons, a lower amount of organic constituents in the flux preparation is desirable, a lower amount of thickener is desirable. Consequently, the higher the amount of phase II salt is in the flux preparation, preferably, the lower is the content of organic thickener.

The flux preparation may include other additives for example, suspension stabilizers, surfactants, especially nonionic surfactants, e.g., Antarox BL 225, a mixture of linear C8 to C10 ethoxylated and propoxylated alcohols.

Aged aqueous flux preparations which are aged for at least 1 hour, having a content of equal to or more than 0.5% by weight, and equal to or lower than 30% by weight, of irreversibly dehydrated K₂AlF₅, from 5 to 50% by weight of the basic flux, and a binder in an amount of from 5 to 20% by weight, optionally thickener in an amount of from 0 to 5% by weight, relative to the total weight of the aqueous flux preparation, are especially preferred. The balance to 100% by weight is constituted by the aqueous carrier which is present, and additives which are optionally present.

The constituents of the flux preparation (phase II salt, a flux which contains the phase II salt, basic flux, brazing alloy, brazing alloy precursor, binder, thickener, additives, if present) and carrier liquid can be provided separately to obtain the flux preparation. In a preferred embodiment, at least the phase II salt, or as described now, a flux containing it, and the basic flux, and optionally additives which facilitate brazing, e.g., the brazing alloy or brazing alloy precursor, or additives which improve the brazed product, e.g., LiF or Li₃AlF₆ can be provided as a flux composition. Using a prefabricated flux composition has the advantage that the manufacture of the flux preparation is easier because the respective constituents must not be added one by the other.

A flux composition which can be used to provide the flux preparation of the present invention is another aspect of the present invention.

The flux composition of the present invention comprises a basic flux for aluminum brazing which contains or consists of at least one compound selected from the group consisting of KAlF₄, K₂AlF₅, CsAlF₄, Cs₂AlF₅, Cs₃AlF₆, KZnF₃, K₂SiF₆, and their hydrates irreversibly dehydrated K₂AlF₅ being excluded from the group of basic fluxes, and equal to or more than 2% by weight of irreversibly dehydrated K₂AlF₅. Preferably, the content of irreversibly dehydrated K₂AlF₅ is equal to or less than 50% by weight, more preferably, equal to or less than 30% by weight, more preferably, equal to or less than 25% by weight of the flux composition. The term “basic flux for aluminum brazing” denotes fluxes which can be applied to braze parts made from aluminum or aluminum alloy to other parts made from aluminum or aluminum alloy, copper, steel or titanium. The term “aluminum alloy” denotes parts the aluminum content of which is equal to or greater than 95% by weight. Of course, the basic flux does not correspond to irreversibly dehydrated K₂AlF₅. Thus, the flux composition of the present invention does not consist of irreversibly dehydrated K₂AlF₅.

In the context of the present invention, the term “comprising” includes the meaning “consisting of”.

Basic fluxes for aluminum brazing are known; they are generally considered to be noncorrosive. Basic potassium fluoroaluminate fluxes are very suitable. See for example, U.S. Pat. No. 3,951,328, 4,579,605 or 6,221,129, or U.S. Pat. No. 3,971,501 which describes a flux based on KAlF₄ and K₃AlF₆. U.S. Pat. Nos. 4,670,067 and 4,689,092 describe a flux based on potassium fluoroaluminate and cesium fluoroaluminate. Those cesium-containing basic fluxes are especially suitable to braze aluminum-magnesium alloys.

Other basic fluxes are also applicable for brazing of aluminum parts.

For example, an alkali metal fluorozincate basic flux, especially a potassium fluorozincate basic flux, can be used. Such basic fluxes are disclosed, for example, in U.S. Pat. No. 6,743,409. A flux based on alkali metal fluorostannates is described in U.S. Pat. No. 6,880,746.

The term “irreversibly dehydrated K₂AlF₅” denotes K₂AlF₅ which was subjected to a heat treatment such that it will not be rehydrated even in contact with water. This specific phase of K₂AlF₅ (hereafter often denoted “phase II salt”) and its manufacture is described in U.S. Pat. No. 5,980,650. By heating K₂AlF₅.H₂O to 90 to 228° C. under quasi-isobaric conditions, and any way to 265° C., a reversibly dehydrated K₂AlF₅ phase is obtained which is hereafter often called “phase I salt”. By heating K₂AlF₅.H₂O or the phase I salt to temperatures above about 265° C., the irreversibly dehydrated K₂AlF₅, the phase II salt, is formed. Under quasi-isobaric conditions, the phase II salt is even formed at temperatures as low as 228° C. While the formation of the phase II salt starts at the relatively low temperatures mentioned above, it is preferred to heat K₂AlF₅.H₂O or the phase I salt to temperatures equal to or above 375° C. Brittle crystals form, and the conversion to the phase II salt is high. It is even possible to heat the starting material to a temperature up to or even higher than 500° C.

If the basic flux is a potassium fluoroaluminate, the invention provides two preferred alternatives.

According to one alternative, the flux composition comprises a potassium fluoraluminate basic flux and at least 2% by weight of irreversibly dehydrated K₂AlF₅ with the proviso that a flux for brazing metal work pieces is disclaimed which comprises irreversibly dehydrated K₂AlF₅ in admixture with at least one other alkali metal salt of a complex aluminum fluoride, wherein said flux consists essentially of from 1 to 97% by weight of KAlF₄; from 1 to 20% by weight of irreversibly dehydrated K₂AlF₅; from 0 to 15% by weight of reversibly dehydrated K₂AlF₅; from 0 to 15% by weight of K₂AlF₅.H₂0; from 0 to 10% by weight of K₃AlF₆; and from 0 to 7% by weight of chemically unbound water. Such a flux is generically disclosed in U.S. Pat. No. 5,980,650 and is not claimed herein as such.

According to another alternative, the flux composition comprises a potassium fluoroaluminate basic flux and irreversibly dehydrated K₂AlF₅, wherein the content of KAlF₄ is from 50 to 90% by weight, the content of irreversibly dehydrated K₂AlF₅ (phase II salt) is from 5 to 50% by weight, and the total content of any form of K₂AlF₅ is from 10 to 50% by weight.

The term “total content of any form of K₂AlF₅” means the sum of irreversibly dehydrated K₂AlF₅, reversibly dehydrated K₂AlF₅, K₂AlF₅.H₂O and any other form of K₂AlF₅ which is not the phase II salt. In this embodiment, the content of KAlF₄ is preferably in the range of from 70 to 90% by weight, the content of irreversibly dehydrated K₂AlF₅ is from 5 to 30% by weight, and the total content of any form of K₂AlF₅ is from 10 to 50% by weight.

In a preferred embodiment of this alternative, the total content of any form of K₂AlF₅ is from 15% by weight to 30% by weight, with the proviso that the content of irreversibly dehydrated K₂AlF₅ (phase II salt) is at least 5% by weight of the total weight of the flux composition. The balance to 100% by weight is KAlF₄ and, if present, undesired trace impurities, for example, K₃AlF₆. The content of the phase II salt is preferably from 5 to 30% by weight of the total flux composition; the content of the other forms of K₂AlF₅ which are not phase II salt is from 0 to 25% by weight of the total flux composition. In especially preferred embodiments of the invention, the total content of any form of K₂AlF₅ is from 15 to 25% by weight of the total weight of the flux composition, and the weight ratio between the irreversibly dehydrated K₂AlF₅ and the other forms of K₂AlF₅ which are not phase II salt is from 2:1 to 1:2.

Optionally, the flux composition of the present invention comprises additives which facilitate the brazing process or improve the properties of the brazed parts.

Additives which facilitate the brazing process are, for example, brazing alloy, for example, aluminum-silicon alloy, or brazing alloy precursors, e.g., silicon, germanium, copper, or potassium hexafluorosilicate or cesium hexafluorosilicate; the hexafluorosilicates are also useful as basic fluxes. Brazing may be easier with a flux composition containing these additives because it is not necessary to clad the parts to be brazed with brazing alloy in a separate step. If present, these additives are preferably contained in an amount equal to or lower than 50% by weight of the total weight of the additives plus the flux composition.

A basic flux comprising potassium fluoroaluminate and lithium fluoride as additive is known from EP-A-0 091231. It is stated that the content of LiF should not fall short of 2% by weight and not exceed 7% by weight.

The use of brazing alloy precursors as additives is described in U.S. Pat. No. 5,100,048; the use of hexafluorosilicates as additives or flux is described in U.S. Pat. No. 6,648,212.

Other additives improve the properties of the brazed parts.

A basic flux comprising Li compounds as additive, especially LiF or Li₃AlF₆, is described in WO 2010/060869 (filing number PCT/EP2009/065566). The content of Li is preferably equal to or greater than 0.1% by weight which corresponds to a content of about 1% by weight (exactly: 0.77% by weight) of Li₃AlF₆ in the modified flux. Generally, the content of Li⁺ in that flux is equal to or lower than 4.6% by weight. This corresponds to a content of about 36% by weight of Li₃AlF₆ in that flux. The Li salt additives improve the resistance of the brazed parts against corrosion.

Another basic flux is described in the unpublished international patent application with the filing number EP2010/051626. The basic flux described therein is suitable for aluminum brazing and contains a basic flux which comprises K₂AlF₅ or a precursor thereof, and a Li salt in an amount which corresponds to from 80% to 120% of the amount which is stoichiometrically needed to convert all K₂AlF₅ to K₂LiAlF₆ during brazing. Preferred Li salts are LiF and Li₃AlF₆.

Other additives which are optionally added to the flux composition are the metal salts disclosed in WO2005/092563. The additives described therein, especially the oxides and fluorides of lanthanum, cerium, niobium, bismuth, zirconium, titanium, improve the surface properties, e.g., provide a higher smoothness, and also improve the brazing alloy flow during brazing. If present, these additives preferably are contained in an amount of equal to or lower than 10% by weight of the total weight of the flux composition.

In the following Tables 1 and 2, preferred flux compositions of the present invention are compiled. “Phase II salt” is irreversibly dehydrated K₂AlF₅. The flux compositions in Table 1 can advantageously be manufactured by mixing essentially pure, irreversibly dehydrated K₂AlF₅ (phase II salt) and basic fluxes consisting essentially of KAlF₄ and K₂AlF₅ forms which are free of phase II salt or which have a certain content of the irreversibly dehydrated K₂AlF₅. A flux consisting essentially of KAlF₄ and K₂AlF₅ and its hydrate which is essentially free of phase II salt is available from Solvay Fluor GmbH as Nocolok® Flux. Essentially pure, irreversibly dehydrated K₂AlF₅ can be manufactured in the following manner: according to example 7 of U.S. Pat. No. 4,579,605, the hydrate of K₂AlF₅ is prepared by reacting hydrofluoric acid with an HF concentration of about 20% by weight, with aluminum hydroxide and then with a potassium lye with a KOH concentration of 25% by weight; the molar ratio of Al:F:K is 1:4:1. The resulting product is then subjected to a heat treatment, preferably above 265° C., as described in U.S. Pat. No. 5,980,650.

TABLE 1
Flux compositions of the present invention*

| Flux N° | Basic flux | Phase II salt | Additive |
|---|---|---|---|
| Flux 1 | KAlF₄/K₂AlF₅**, 95% | 5% | — |
| Flux 2 | KAlF₄/K₂AlF₅**, 90% | 10% | — |
| Flux 3 | KAlF₄/K₂AlF₅**, 85% | 15% | |
| Flux 4 | KAlF₄/K₂AlF₅**, 80% | 20% | |
| Flux 5 | KAlF₄/K₂AlF₅**, 75% | 25% | |
| Flux 6 | KAlF₄/K₂AlF₅**, 90% | 30% | |
| Flux 7 | KAlF₄/K₂AlF₅**, 60% | 10% | Si powder, 30% |
| Flux 8 | KAlF₄/K₂AlF₅**, 80% | 10% | Li₃AlF₆, 10% |
| Flux 9 | Cs_{0.02}K_{y}AlF_{z}***, 80% | 10% | Li₃AlF₆, 10% |
| Flux 10 | Cs_{0.02}K_{y}AlF_{z}***, 50% | 50% | |
| Flux 11 | Cs_{0.02}K_{y}AlF_{z}***, 60% | 10% | Si powder, 30% |
| Flux 12 | KZnF₃ 80% | 20% | — |
| Flux 13 | KZnF₃ 50% | 20% | Si powder 30% |

*Amounts in % by weight of the total flux composition
**The basic flux is available as Nocolok ® Flux from Solvay Fluor GmbH, Hannover, Germany. The weight ratio KAlF₄:K₂AlF₅ in this flux is about 80:20. The basic flux is essentially free of phase II salt.
***A mixture of CsAlF₄, KAlF₄ and K₂AlF₅ such that y is about 1-2 and z is 4-5. The mixture is available as Nocolok ® Cs Flux from Solvay Fluor GmbH, Hannover, Germany

The fluxes in Table 2 comprise both phase II salt and other forms of K₂AlF₅ which are not phase II salts. The total content of any forms of K₂AlF₅ is preferably in the range of from 15 to 25% by weight, very preferably, it is about 20±2% by weight; the weight ratio of phase II salt to the forms of K₂AlF₅ which are not phase II is preferably from 1:2 to 2:1. Such fluxes are preferably produced in the following manner. In a first step, a precipitated potassium fluoroaluminate consisting essentially of KAlF₄ and K₂AlF₅ is prepared. A suitable method is described in U.S. Pat. No. 4,428,920. Fluoroaluminum acid, preferably freshly prepared from alumina and hydrofluoric acid, is reacted with a potassium compound, especially potassium lye, in a precipitation stage to form potassium fluoroaluminate. The concentration of the fluoroaluminum acid is preferably in the range of from 5 to 30% by weight, the concentration of KOH in the potassium lye is preferably between 2 and 25% by weight. The molar ratio of potassium to aluminum is preferably between 0.60:1 and 0.95:1. The proportion of fluorine to aluminum is within the range of from 4.0:1 to 4.8:1. According to U.S. Pat. No. 5,968,288 the process may be performed by adding potassium cryolite to the precipitation stage. The precipitated potassium fluoroaluminate with varying amounts of K₂AlF₅ can also be prepared in the manner described in examples 9 to 11 of U.S. Pat. No. 4,579,605 by varying the reaction temperature of the hydrofluoric acid solution, potassium lye and alumina.

The precipitated potassium fluoroaluminate which comprises essentially no phase II salt when manufactured in the precipitating step as described is then subjected to a second step which can be performed according to two alternatives.

According to a first alternative, the precipitated potassium fluoroaluminate is heated to a temperature for a period of time such that only the desired proportion of K₂AlF₅ or the hydrate thereof is converted to the phase II salt. The degree of conversion can be monitored by X ray diffraction analysis, thermal differential analysis and elementary analyses of fluorine and aluminum as mentioned in U.S. Pat. No. 4,579,605, column 3, line 53 to column 4, line 10.

According to the second alternative, the basic flux is prepared by mixing, in the desired ratio, precipitated flux which was not treated to convert K₂AlF₅ into phase II salt, and precipitated potassium fluoroaluminate which was thermally treated such that essentially all K₂AlF₅ is converted to phase II salt. This alternative is preferred to the other alternative because the desired ratio of phase II salt to other forms of K₂AlF₅ which are not phase II salts can be set very exactly.

In Table 2, flux compositions are compiled which are obtained by mixing precipitated, dried flux and thermally treated flux in which only phase II salt is present. The content of KAlF₄ in the dried precipitated flux is about 80% by weight, just like in the thermally treated flux. Thus, also in the mixture, the overall content of KAlF₄ is about 80% by weight. The overall content of K₂AlF₅ (total content of all forms including phase II) in the formed flux composition is about 20% by weight.

TABLE 2
Flux composition, optionally with additives, comprising phase II
salt and other forms of K₂AlF₅, obtained by mixing flux containing
no phase II salt (“non-phase II”) and flux containing K₂AlF₅
only in the form of phase II salt (“phase II”).

| | Content | Content | Content of | Total content | |
|---|---|---|---|---|---|
| Flux N° | KAlF₄ | phase II | non-phase II | K₂AlF₅ | Additives |
| 14* | 80 | 5 | 15 | 20 | — |
| 15** | 80 | 10 | 10 | 20 | — |
| 16*** | 80 | 15 | 5 | 20 | — |
| 17+ | 56 | 7 | 7 | 14 | Si: 30 |
| 18++ | 73 | 9 | 9 | 18 | Li₃AlF₆: 9 |

Content is given in % by weight
*Obtained by mixing 5 parts of Nocolok ® Flux, heat treated up to 475° C., and 15 parts of untreated Nocolok ® Flux
**Ditto, but 10 parts of heat treated Nocolok ® Flux and 10 parts of untreated Nocolok ® Flux were mixed
***Ditto, but 15 parts of heat treated Nocolok ® Flux and 5 parts of untreated Nocolok ® Flux were mixed
+Obtained by mixing 7 parts of flux N° 15 and 3 parts of Si powder
++Obtained by mixing 91 parts of flux N° 15 and 9 parts of Li₃AlF₆

A method for the manufacture of the flux compositions is another aspect of the present invention.

The invention provides a method for the manufacture of flux composition of the present invention comprises a basic flux for aluminum brazing and equal to or more than 2% by weight of irreversibly dehydrated K₂AlF₅ wherein
a) a basic flux is combined with irreversibly dehydrated K₂AlF₅, or
b) a flux comprising K₂AlF₅ which is not irreversibly dehydrated is heat-treated to convert at least a part of the not irreversibly dehydrated K₂AlF₅ to irreversibly dehydrated K₂AlF₅, or
c) a flux comprising K₂AlF₅ irreversibly dehydrated is mixed with a flux comprising not irreversibly dehydrated K₂AlF₅.

According to the first alternative, irreversibly dehydrated K₂AlF₅ is added to any basic flux which is useful for brazing parts of aluminum or parts of aluminum alloys to parts of aluminum, aluminum alloys, copper, steel or titanium. Preferably, the K₂AlF₅ is essentially pure; preferably, the content of irreversibly dehydrated K₂AlF₅ is equal to or higher than 98% by weight. Balance to 100% by weight is constituted by undesired impurities, e.g., water, other forms of K₂AlF₅, KAlF₄, or K₃AlF₆. Basic fluxes which are preferred are mentioned above. Most preferred basic fluxes are KAlF₄, K₂AlF₅, cesium fluoroaluminate, and any mixtures thereof; potassium fluorozincate, cesium fluorozincate and any mixtures thereof; and potassium fluorostannate, cesium fluorostannate.

According to the second alternative, a flux which comprises K₂AlF₅ which is in a form other than phase II, e.g., K₂AlF₅ or reversibly dehydrated K₂AlF₅, is heat-treated such that at least a part of the K₂AlF₅ is converted to irreversibly dehydrated K₂AlF₅. Generally, the flux is heated to a temperature above about 265° C. to achieve conversion of a part or all of the K₂AlF₅ present.

According to third alternative, a flux which comprises irreversibly dehydrated K₂AlF₅ is combined with a flux which comprises other phases of K₂AlF₅. This alternative is preferably applied for providing a potassium fluoroaluminate flux composition. Preferred flux compositions which can be manufactured according this method are described above. The third alternative is especially preferably applied to manufacture a flux composition which comprises from 75 to 85% by weight of KAlF₄, the balance to 100% by weight being K₂AlF₅, and the weight ratio of phase II salt to other forms of K₂AlF₅ is preferably from 2:1 to 1:2.

Often, it is preferred to mix the components thoroughly to achieve homogeneity of the flux composition.

If it is intended to prepare a flux composition comprising additives, then the respective additive or additives can be added to the flux composition or to any of the components prior to mixing them, e.g., to the basic flux or to the irreversibly dehydrated K₂AlF₅. Preferred additives, especially Si, LiF and Li₃AlF₆, and their function are described above.

The flux compositions, optionally containing one or more additives as explained in detail above, are useful for any method of applying them to the parts to be brazed. They can, for example, be applied in a dry method, e.g., electrostatically. They can also be applied in a wet method wherein the flux composition and any additive, if present, is dispersed in an organic carrier, e.g., a monobasic alcohol, for example, ethanol or isopropanol, or a dibasic alcohol, for example, glycol. The dispersion can be sprayed on the parts, painted on the parts, or be applied by immersing the parts into the wet preparation.

As mentioned above, the flux compositions of the present invention are preferably applied to provide the aqueous flux preparation explained in detail above.

Consequently, a preferred aged aqueous flux preparation comprises the flux composition as presented in detail above. The expert skilled in the art will understand that in the aqueous aged flux preparation, the “flux composition” will often not be present as such. It is assumed that the constituents of the flux composition will separate when they are dissolved or dispersed in the aqueous carrier. Thus, the term “a flux preparation comprising the flux composition of the present invention and an aqueous carrier” has the same meaning as “a flux preparation comprising the components of the flux composition of the present invention and an aqueous carrier”. For the sake of simplicity, the term “a flux preparation comprising the flux composition” will be used in connection to the further description of the flux preparation.

As is described below, high shearing forces may reduce the viscosity of certain aged flux preparations. Preferably the flux preparations of the present invention are not subjected to shearing forces which reduce the viscosity and sedimentation behavior to an undesired lower level.

In the following Table 3, concrete examples of preferred aged flux preparations are compiled. The carrier is water. The aging time is calculated from the moment of mixing water and flux composition and the moment of measuring the dynamic viscosity in MP31 (50 mm, 0°); the gap width was d=0.500 mm; the measurements were performed at ambient temperature at a shear-rate of 1000 [1/s]. The figures of the content are given in % by weight of the total flux preparation, the dynamic viscosity is given in [mPa·s]. The flux composition applied was obtained by mixing heat-treated and not heat-treated flux (consisting of KAlF₄ and K₂AlF₅ and its hydrate with about 80% by weight of KAlF₄, obtainable as Nocolok® Flux). In the heat-treated flux, the K₂AlF₅ content was completely present as irreversibly dehydrated K₂AlF₅. The column “flux content” indicates the content of flux in the preparation. The “share of phase II” refers to the content of the phase II salt in the total amount of K₂AlF₅ present where the total amount of total amount of K₂AlF₅ present is set to 100%. The column “aging time” gives the time in hours and denotes the time passed since the flux preparation was manufactured and the moment of determination of the viscosity, i.e., gives the time of contact between water and phase II salt.

TABLE 3
Preferred aged compositions

| | | Share of | Dynamic | Aging |
|---|---|---|---|---|
| Preparation N° | Flux | phase II | viscosity | time |
| 1 (comparison) | 40 | 0 | 22 | 0.2 |
| 2 | 40 | 25 | 32 | |
| 3 | 40 | 50 | 27 | |
| 4 | 40 | 75 | 27 | |
| 5 | 40 | 100 | 55 | |
| 6 (comparison) | 40 | 0 | 20 | 1.0 |
| 7 | 40 | 25 | 35 | |
| 8 | 40 | 50 | 84 | |
| 9 | 40 | 75 | 123 | |
| 10 | 40 | 100 | 108 | |
| 11 (compar.) | 40 | 0 | 20 | 2.0 |
| 12 | 40 | 25 | 36 | |
| 13 | 40 | 50 | 79 | |
| 14 | 40 | 75 | 107 | |
| 15 | 40 | 100 | 145 | |
| 16 (compar.) | 40 | 0 | 21 | 24.0 |
| 17 | 40 | 25 | 36 | |
| 18 | 40 | 50 | 55 | |
| 19 | 40 | 75 | 77 | |
| 20 | 40 | 100 | 164 | |

In Table 4, especially preferred aqueous flux preparations which comprise a binder are compiled. The binder was a water-miscible polyurethane dispersion, the thickener was Nocolok® Thickener, containing a polyurethane. The amounts of flux, binder and thickener are given in % relative to the total weight of the flux preparation. The carrier was water. The sedimentation volume was measured by filling 100 ml of the flux preparation into a graduated measuring cylinder with a volume of 100 ml. The sedimentation volume was measured after 24 hours after giving the flux preparation into the cylinder. Thus, the aging time was longer than 24 h. The value “Share PII” again gives the content of phase II salt in the total weight of K₂AlF₅ set to 100%. The flux composition was prepared as described for the flux preparations of Table 3. The sedimentation volume is given in ml. “(comp.)” denotes comparison examples.

TABLE 4

| | | | | Share | Sedimentation |
|---|---|---|---|---|---|
| Prep. N° | Flux | Binder | Thickener | PII | volume |
| 21 (comp.) | 35 | 15 | 5 | 0 | 78 |
| 22 | 35 | 15 | 5 | 50 | 91 |
| 23 | 35 | 15 | 5 | 100 | 97 |
| 24 (comp.) | 35 | 15 | 0 | 0 | 68 |
| 25 | 35 | 15 | 0 | 50 | 86 |
| 26 | 35 | 15 | 0 | 100 | 97 |
| 27 (comp.) | 30 | 15 | 0 | 0 | 62 |
| 28 | 30 | 15 | 0 | 50 | 81 |
| 29 | 30 | 15 | 0 | 58 | 82 |
| 30 | 30 | 15 | 0 | 67 | 83 |
| 31 | 30 | 15 | 0 | 75 | 85 |
| 32 | 30 | 15 | 0 | 83 | 87 |
| 33 | 30 | 15 | 0 | 92 | 92 |
| 34 | 30 | 15 | 0 | 100 | 100 |
| 35 (comp.) | 30 | 15 | 2.5 | 0 | 64 |
| 36 | 30 | 15 | 2.5 | 25 | 64 |
| 37 | 30 | 15 | 2.5 | 50 | 75 |
| 38 | 30 | 15 | 2.5 | 75 | 83 |
| 39 | 30 | 15 | 2.5 | 100 | 89 |
| 40 (comp.) | 30 | 15 | 5 | 0 | 65 |
| 41 | 30 | 15 | 5 | 25 | 68 |
| 42 | 30 | 15 | 5 | 50 | 76 |
| 43 | 30 | 15 | 5 | 75 | 85 |
| 44 | 30 | 15 | 5 | 100 | 88 |
| 45 (comp.) | 40 | 0 | 0 | 0 | 82 |
| 46 | 40 | 0 | 0 | 50 | 88 |
| 47 | 40 | 0 | 0 | 100 | 89 |

The flux preparation of the invention is preferably prepared as follows.

Flux composition (or, as mentioned above, the respective separate components if it is desired to apply them separately from each other) and aqueous carrier, preferably water, are given into a vessel suitable for mixing the components. In this vessel, the flux composition and any other solid or liquid constituent not contained in the flux composition is dispersed in the carrier in a dispersing step. It was observed by the inventors that the dynamic viscosity which is tentatively explained by intermolecular forces forming between the phase II salt and water molecules, increases slowly. Even after 10 minutes of contact between phase II molecules and water molecules, the dynamic viscosity of the flux preparation of the invention is much higher. After 1 hour, the dynamic viscosity is still considerably higher, and after 24 hours, a very high viscosity level is reached. Contrary thereto, in a flux preparation comprising no phase II salt, no change of the dynamic viscosity is observed at all. Thus, according to a preferred embodiment, the flux preparation is provided such that the contact between water, if desired in the form of a mixture with an organic liquid as explained above, and the phase II salt is extended to 12 or more minutes, preferably equal to or more than 20 minutes, preferably to at least 30 minutes before the flux preparation is used for brazing.

Also the sedimentation behavior improves after the preparation of the flux. Immediately after the manufacture of the flux preparation, the sedimentation volume decreases with time. According to a measurement 30 minutes after dispersing the flux composition in water, the sedimentation volume of the solids remains essentially constant. Contrary thereto, the sedimentation volume of comparable fluxes without phase II salt present continues to decrease after 30 minutes.

As described above, it was observed that the flux compositions comprising phase II salt provide an aqueous flux preparation with higher viscosity, compared to fluxes without phase II salt. As mentioned, a tentative explanation is the formation of intermolecular forces between water and phase II salt. It was observed that the shearing forces have no influence on the dynamic viscosity when the flux preparation is prepared. After the increase of the dynamic viscosity has taken place (allocated to the formation of the intermolecular forces mentioned above), shearing forces applied to the dispersion may have some impact on the viscosity. Up to a certain level of shearing forces, the high dynamic viscosity of the aqueous flux preparations containing manufactured under dispersion of the phase II salt does not increase or it increases only to a tolerable degree. Above that level, the dynamic viscosity decreases to a level observed with comparable aqueous flux preparations which do not contain a phase II salt when prepared.

The level of the shearing force which has an undesired impact on the level of the dynamic viscosity may be dependant from the individual dispersed flux preparation, e.g., from the temperature, the concentration of the phase II salt, the amount of binder etcetera. The inventors performed tests in which the flux preparation was prepared using a dissolver Disperlux Laboratorium DissolverModel 2027 Green-Line operated at a disk speed of 800 cycles per minute. After the high level of the dynamic viscosity had formed, the dynamic viscosity of the resulting aqueous flux preparation was determined using a Rheolab MC1 apparatus. The measuring system was MP31 (50 mm, 0°); the gap width was d=0.500 mm; the measurements were performed at ambient temperature. The shear-rate was selected to be between 1000 [1/s] to 3000 [1/s]. At a shear-rate of 1000 [1/s], the dynamic viscosity remained at a very high level, much higher that that of aqueous flux preparations without phase II salt. At a shear-rate of 3000 [1/s], the dynamic viscosity still was much higher than the dynamic viscosity of aqueous flux preparations containing no phase II salt. When the aqueous flux preparation of the present invention was subjected to very high shear-rates, such as in a dissolver operated at 6.500 cycles per minute, the dynamic viscosity is comparable to that of aqueous flux preparations without phase II salt in those cases where the flux content was 30% by weight.

The acceptable maximal shear-rate for concrete aqueous flux preparations can be easily determined by simple tests as described above in apparatus for the determination of dynamic viscosities. A preferred upper limit for the shear-rate is assumed to be 5000 [1/s], more preferably, 3000 [1/s], most preferably 1500 [1/s].

In all the experiments, the dynamic viscosity was measured at a temperature between about 22.8° C. and 24.8° C.

The sedimentation behavior is negatively impacted by high shearing forces, too. When the flux preparation was post-treated in the Disperlux Laboratory Dissolver with a disk having a diameter of 40 mm at a speed of 6.500 cycles per minute, the high level of the sedimentation volume decreased to the level of a flux preparation containing no phase II salt for compositions containing 30% by weight of the flux.

The details given above for a carrier consisting essentially of water can also be applied for the embodiment wherein the carrier comprises water and an organic liquid.

Another aspect of the present invention is a process for brazing parts of aluminum or parts of aluminum alloys to parts aluminum, aluminum alloys, steel, copper or titanium. The process of the present invention comprises a brazing step wherein parts of aluminum or aluminum alloy are joined to parts of aluminum, aluminum alloys, steel, copper or titanium wherein an aqueous flux preparation is provided comprising dispersed phase II salt, the flux preparation is coated onto at least one of the parts to be joined, and the parts are heated in the presence of a brazing alloy or a brazing alloy precursor until a brazed joint has formed. The brazing temperature is known to the expert. It depends mainly on the brazing alloy or a brazing alloy precursor and the flux applied. For aluminum brazing using a potassium fluoroaluminate flux, the brazing is performed usually at a temperature at about 580 to 615° C. or higher.

In a preferred embodiment, an aqueous flux preparation is applied which was prepared at least 12 minutes, preferably 20 minutes, more preferably at least 30 minutes, more preferably, at least 1 hour before it is coated on the parts to be brazed.

In a preferred embodiment, an aqueous flux preparation is applied which, later than 12 or minutes, preferably later than 20 minutes after its preparation, was not subjected to shear-rates which reduce the dynamic viscosity of the aqueous flux preparation at ambient temperature by equal to or more than 80%, preferably, by equal to or more than 50%, and especially preferably, by equal to or more than 20%. Preferably, the shear-rates are equal to or lower than the shear-rates subjected, at ambient temperature, i.e., at about 20° C., on the aqueous flux preparation at 5000 [1/s], preferably, equal to or lower than 3000 [1/s], most preferably, equal to or lower than 1500 [1/s], by a Rheolab MC1 apparatus, the measuring system being MP31 (50 mm, 0°), and a gap width was d=0.500 mm.

The aqueous flux preparation is preferably applied to the part or parts to be brazed by spraying it onto the parts, by painting it onto the part or parts or by immersing the part or parts into the flux preparation.

In one embodiment, the flux preparation is used in a pre-fluxing application. In this type of application, the flux preparation is coated on the parts to be brazed, e.g., by spraying or painting, and then is dried to provide a part coated with the dry flux preparation. The part is then stored or transported to a brazing facility where it is brazed. The advantage is that the end user can immediately use the pre-fluxed part for brazing. A pre-fluxed part coated with the dried flux preparation of the present invention is another aspect of the present invention.

The flux preparation is preferably applied in an amount that the weight of the flux is about 5 to 40 g/m².

After brazing, the brazed parts can be subjected to a post treatment to improve the anticorrosive properties thereof. A method to improve the anticorrosive properties of brazed parts is described in international patent application WO 2009/127707. According to that patent application, the parts can be subjected to post treatment by heating them to between about 400° C. and 550° C. in an oxygen containing atmosphere, e.g., in air. Alternatively, or additionally, the brazed parts can be treated with a calcium salt as fluoride scavenger or with compounds which reduce the solubility of the flux residues. Potassium salts are highly suitable when a potassium containing flux was applied. Salts with AlF₄ ions, AlF₅ ions and AlF₆ ions are also suitable, e.g., the respective potassium salts.

Another aspect concerns the use of the phase II salt as thickener for aqueous flux preparations. In this aspect, a method is provided for increasing the viscosity of aqueous flux preparations for brazing of parts of aluminum or parts of aluminum alloys to parts of aluminum, aluminum alloys, steel, copper or titanium wherein irreversibly dehydrated K₂AlF₅ is added as thickener. In this method, irreversibly dehydrated K₂AlF₅ is preferably added in an amount of equal to or greater than 5% by weight of the total flux preparation.

Preferably, the amount of irreversibly dehydrated K₂AlF₅ is equal to or lower than 50% by weight of the total flux preparation. Preferably, the flux preparation is aged for at least 12 minutes. Preferably, the flux preparation is aged for equal to or less than 3 days.

The advantage of the present invention is that the flux composition provides an aqueous flux preparation which has a higher viscosity than comparable other flux preparations. Thus, the adhesion to parts to be brazed is very good, the effectivity of the flux preparation is very high because there is less drop-off from the coated parts, the content of thickener can be reduced or even set to zero, and thus, the environmental compatibility is very high.

Should the disclosure of any patents, patent applications, and publications which are incorporated herein by reference conflict with the description of the present application to the extent that it may render a term unclear, the present description shall take precedence.

The following examples explain the invention in detail without the intention to limit it.

### EXAMPLES

### Example 1

### Preparation of a Flux Consisting of KAlF₄ and Irreversibly Dehydrated K₂AlF₅ in a Weight Ratio of about 4:1

### Example 1.1

A flux consisting of KAlF₄ and K₂AlF₅ containing about 80% by weight of KAlF₄, the balance to 100% by weight being K₂AlF₅ and its hydrate, the content of phase II salt being 0, available as Nocolok® Flux from Solvay Fluor GmbH, Hannover, Germany, was subjected to a heat treatment in an oven. The oven was flushed with nitrogen, the flux to be heat treated was put into the oven, and the temperature of the oven was brought slowly to the final temperature of 430° C. The flux was kept at that temperature for 32 minutes, and then the temperature was slowly brought back to ambient temperature. The produced flux composition was analyzed by X-ray diffraction (XRD). The K₂AlF₅ was present completely in the form of the phase II salt.

### Examples 1.2 to 1.9

Example 1.1 was repeated. The flux was brought to the following maximum temperatures (in brackets: holding time at the temperature in minutes):

440° C. (38); 390° C. (45); 450° C. (32); 435° C. (50); 475° C. (64); 450° C. (67); 462° C. (63); 440° C. (60) and 475° C. (75). In all cases, a complete conversion of the K₂AlF₅ content to the phase II salt was observed.

The X90 value for all flux compositions was between 9.36 and 11.03 μm (i.e., the 90% of all particles had a diameter of equal to or less than 9.36 and equal to or less than 11.03 μm). The X50 value was between 3.37 and 4.81 μm. The X10 value was between 0.86 and 1.17 μm.

The untreated flux (2 samples) had an X90 value of 8.1 and 8.48 μm, an X50 value of 2.6 and 2.65 μm, and an X10 value of 0.75 and 0.76 μm.

The values are measured in the following manner:

Used device: Sympatec HELOS with powder dry-dispersion unit Rodos.

Software version used for measurements: Sympatec HELOS (device no. H1132) RODOS: HRLD (V03.03. Rel.1) and Sympatec HELOS (device no. H2068) RODOS: HRLD (5.3.0.0). HRLD means high resolution laser diffraction.

Particle size distributions were measured by Laser Diffraction (method: Fraunhofer Approximation).

For the measurements a portion of the powder is dispersed in a stream of nitrogen gas by the means of a nozzle. The powder cloud then is passed perpendicular by a Laser-beam. The Laser-beam is diffracted by the powder particles within the powder cloud. The resulting diffraction angle and intensity distribution is dependant on the particle size and concentration of the particles (regarding particle size). The resulting diffraction pattern is detected by a light sensitive array detector. From the detected signal (diffraction pattern) the particle size distribution is subsequently calculated by a mathematical method called Fraunhofer approximation for round particles.

### Example 2

### Sedimentation Behavior of Flux Preparations Aged for 0 to 120 Minutes

General procedure: 20 g of a flux composition of Example 1 (heat-treated flux with 20% by weight of phase II salt, balance to 100% was KAlF₄, share of phase II salt in the total K₂AlF₅ content was 100%; X90=9.40 μm, X50=3.57 μm, X10=0.91 μm; heat treated to about 430° C.), and the untreated flux (X90=8.09 μm, X50=2.59 μm, X10 0 0.75 μm; 80% by weight of KAlF₄, no phase II salt) for comparison were mixed with 80 ml de-ionized water in a graduated measuring cylinder with an inner volume of 100 ml. The cylinder was closed and shaken by hand for 1 minute. Then, shaking was stopped, and the sedimentation behavior was determined by controlling the sedimentation volume (phase boundary of suspension and liquid phase in ml) after indicated periods of time.

First cycle: the sedimentation volume was determined after 0, 30, 45 and 60 minutes after stopping of the first shaking of the cylinder.

Second cycle: After 60 minutes, the cylinder was shaken again for a minute, and once again, the sedimentation volume was determined after 0, 30, 45 and 60 min after stopping the shaking.

Third cycle: as second cycle, but performed 120 minutes after the first shaking of the cylinder was performed. The sedimentation volume was determined after 24 hours of settling time.

The results are given in Table 5. The phase boundary is given in ml.

TABLE 5
Sedimentation volumes of flux preparations after shaking

Phase boundary

| | | |
|---|---|---|
| Time after | Heat-treated flux | Untreated flux |
| shaking | of Example 1 | (comparison) |

First cycle

| | | |
|---|---|---|
| 0 | 87 | 87 |
| 30 | 61 | 61 |
| 45 | 61 | 55 |
| 60 | 61 | 52 |

Second cycle, started 60 minutes after first
shaking, after shaking the settled sample again

| | | |
|---|---|---|
| 0 | 86 | 87 |
| 30 | 84 | 62 |
| 45 | 84 | 55 |
| 60 | 84 | 52 |

Third cycle, started 120 minutes after first
shaking, after shaking the settled sample again

| | | |
|---|---|---|
| 0 | 86 | 87 |
| 30 | 86 | 70 |
| 45 | 86 | 58 |
| 60 | 86 | 51 |
| Sedimentation volume, | 85 | 38 |
| read after 24 hours | | |

The data demonstrate that the flux preparation of the present invention is highly superior to a standard flux in view of the long term sedimentation behavior.

### Example 3

### Viscosity of Aged Flux Preparations without Binder and without Thickener

General procedure: The flux used in Example 2, or the untreated flux used in Example 2, and de-ionized water, flux content 40% by weight, were given, after 0.2 hours, 1 hour, 2 hours and 24 hours after their preparation, respectively, into a Rheolab MC1 apparatus. The measuring system was MP31 (50 mm, 0°); the gap width was d=0.500 mm; the measurements were performed at ambient temperature after 12 minutes, 1 hour, 2 hours and 24 hours. The shear-rate was 1000 s⁻¹.

TABLE 6
Dynamic viscosity in mPa · s of flux preparations

| Flux | Viscosity [mPa · s] | | | |
|---|---|---|---|---|
| preparation | After 0.2 h | After 1.0 h | After 2.0 h | After 24.0 h |
| Heat treated | 61 | 119 | 123 | 190 |
| flux used | | | | |
| in ex. 2 | | | | |
| Untreated flux | 22 | 20 | 20 | 21 |

The data of Example 3 demonstrate that the flux preparation of the present invention has a much higher viscosity than the flux preparation with an untreated flux.

### Example 4

### Flux Preparations, without Binder and Thickener, with Varying Share of Phase II Salt, Applying a Shear-Rate of 1000 s⁻¹

General procedure: A heat treated flux comprising 20% of irreversibly dehydrated phase K₂AlF₅, the balance to 100% weight being KAlF₄, and untreated Nocolok®Flux with 80% by weight of KAlF₄ and 20% by weight of K₂AlF₅ and its hydrate, free of phase II salt, were mixed in the proportions given in Table 3.40 g of the flux was mixed with 60 g of de-ionized water. The dynamic viscosity was determined exactly as stated in Example 6. The data are compiled in Table 3 in the description. The data demonstrate that the aged flux preparation with heat treated flux is superior to an untreated standard flux.

### Example 5

### Flux Preparations, without Binder and Thickener, with Varying Share of Phase II Salt, Applying a Shear-Rate of 3000 s⁻¹

Example 4 was repeated, but the shear-rate in the rotation viscosimeter MC1 was set to 3000 s⁻¹. The results are compiled in Table 7.

TABLE 7
Dynamic viscosity in mPa · s, shear-rate set to 3000 s⁻¹

| | | Share of | Dynamic | Aging time |
|---|---|---|---|---|
| Preparation N° | Flux [% wt] | phase II [%] | viscosity | [h] |
| 1 (comparison) | 40 | 0 | 15 | 0.2 |
| 2 | 40 | 25 | 18 | |
| 3 | 40 | 50 | 17 | |
| 4 | 40 | 75 | 18 | |
| 5 | 40 | 100 | 25 | |
| 6 (comparison) | 40 | 0 | 14 | 1.0 |
| 7 | 40 | 25 | 18 | |
| 8 | 40 | 50 | 34 | |
| 9 | 40 | 75 | 46 | |
| 10 | 40 | 100 | 35 | |
| 11 (compar.) | 40 | 0 | 14 | 2.0 |
| 12 | 40 | 25 | 18 | |
| 13 | 40 | 50 | 36 | |
| 14 | 40 | 75 | 46 | |
| 15 | 40 | 100 | 53 | |
| 16 (compar.) | 40 | 0 | 14 | 24.0 |
| 17 | 40 | 25 | 20 | |
| 18 | 40 | 50 | 32 | |
| 19 | 40 | 75 | 40 | |
| 20 | 40 | 100 | 66 | |

The data demonstrate that the flux preparation according to the invention is superior in view of the dynamic viscosity when compared with a standard flux preparation even when higher shearing forces are applied. The data of Example 4 (as compiled in Table 3) and Example 5, Table 7, also demonstrate that higher shearing forces reduce the dynamic viscosity of the flux preparation of the invention.

### Example 6

### Aged Flux Preparations and their Dynamic Viscosity

General procedure: As in Example 3, heat treated flux containing 80% weight of KAlF₄ and the balance to 100% by weight being phase II salt (irreversibly dehydrated K₂AlF₅), were mixed with de-ionized water, binder and optionally thickener such that the content of the constituents in the resulting flux preparation was as given in Table 8. It was found out that the binder preferably is added after the other constituents. The flux preparations were aged as indicated, and the dynamic viscosity was determined as usual in the apparatus MC1, after certain days after their manufacture as indicated in Table 8. The shear-rate was set to 3000 s⁻¹. The data are compiled in Table 8.

TABLE 8
Aged compositions comprising binder and optionally,
thickener, and their dynamic viscosity.

| | | | Share | | Measured |
|---|---|---|---|---|---|
| | Flux | Binder/Thickener | PII | Dyn. Visc. | after |
| Prep. N° | {% wt} | [% wt] | [%] | [mPa · s] | [d] |
| 1 (comp.) | 35 | 15/5 | 0 | 78 | 7 |
| 2 | 35 | 15/5 | 50 | 91 | 11 |
| 3 | 35 | 15/5 | 100 | 97 | 11 |
| 4 (comp.) | 35 | 15/0 | 0 | 68 | 11 |
| 5 | 35 | 15/0 | 50 | 86 | 11 |
| 6 | 35 | 15/0 | 100 | 97 | 11 |
| 7 (comp.) | 30 | 15/0 | 0 | 62 | 11 |
| 8 | 30 | 15/0 | 50 | 81 | 12 |
| 9 | 30 | 15/0 | 58 | 82 | 12 |
| 10 | 30 | 15/0 | 67 | 83 | 12 |
| 11 | 30 | 15/0 | 75 | 85 | 12 |
| 12 | 30 | 15/0 | 83 | 87 | 12 |
| 13 | 30 | 15/0 | 92 | 92 | 12 |
| 14 | 30 | 15/0 | 100 | 100 | 12 |
| 15 (comp.) | 30 | 15/2.5 | 0 | 64 | 3 |
| 16 | 30 | 15/2.5 | 25 | 64 | 11 |
| 17 | 30 | 15/2.5 | 50 | 75 | 11 |
| 18 | 30 | 15/2.5 | 75 | 83 | 11 |
| 19 | 30 | 15/2.5 | 100 | 89 | 11 |
| 20 (comp.) | 30 | 15.5 | 0 | 65 | 3 |
| 21 | 30 | 15/5 | 25 | 68 | 11 |
| 22 | 30 | 15/5 | 50 | 76 | 11 |
| 23 | 30 | 15/5 | 75 | 85 | 11 |
| 24 | 30 | 15/5 | 100 | 88 | 11 |
| 25 (comp.) | 40 | 0/0 | 0 | 82 | 2 |
| 26 | 40 | 0/0 | 50 | 88 | 2 |
| 27 | 40 | 0/0 | 100 | 89 | 2 |

The flux preparations 1 to 27 of this example correspond to the flux preparations N° 21 to 47 of Table 4.

The data show that for flux preparations comprising up to 40% by weight of the flux composition, the addition of a thickener increases the dynamic viscosity. Flux preparations of the invention with a higher content of flux composition have a higher dynamic viscosity even without thickener than flux preparations with a lower flux content; see for example, flux preparations N° 5, 17 and 22. Thus, the flux preparations of the present invention allow the reduction of thickener without reduction in the dynamic viscosity.

### Example 7

### Preparation of a Si Containing Flux

The heat treated flux of Example 1.1 (Nocolok® Flux) consisting from about 80% by weight of KAlF₄ and about 20% by weight of phase II salt, and untreated flux consisting of KAlF₄ and K₂AlF₅ and its hydrate which is free of phase II salt, are mixed in a weight ratio of 1:1. 70 g of this 1:1 flux composition are mixed with 30 g of Si powder, average particle size 17.5 μm. 50 g of the resulting composition are mixed in a vessel with 35 ml de-ionized water. Then, 15 g of polyurethane binder are added. The resulting mixture is left standing at ambient temperature for at least 1 h before it is used for brazing.

### Example 8

### Preparation of a Fluorozincate Flux

A flux consisting essentially of K₂AlF₅.H₂O, with minor amounts (about 1.5% by weight) KAlF₄, is manufactured according to Example 7 of U.S. Pat. No. 4,579,605 at 30° C. from hydrofluoric acid with an HF concentration of 20% by weight, alumina and potassium lye with a KOH concentration of 25% by weight, molar ratio Al:F:K of 1:4:1. The resulting product is subjected to a heat treatment wherein it is heated up to about 430° C. until all K₂AlF₅.H₂O is converted to phase II salt. 30 g of KZnF₃ powder are mixed with 5 g of the phase II salt. 50 ml of de-ionized water are added in a beaker, and 15 g of polyurethane binder are added under mixing. The resulting flux preparation is left standing at ambient temperature at least 30 minutes before applying it for brazing.

General procedure for brazing: the brazing experiments are performed in an oven with nitrogen atmosphere. The parts are heated therein up to the temperature indicated in the examples. The parts are then taken out of the oven and are cooled.

### Example 9

### Brazing with Aqueous Flux Preparations Comprising Phase II Salt

### Example 9.1

30 g of the flux composition of Example 1 (weight ratio of heat treat and untreated flux 1:1) are mixed with 55 g of de-ionized water and 15 g of polyurethane binder in a beaker. The resulting flux preparation is aged for 1 hour (time span since first contact of the phase II salt and water).

An aluminum (AA3003) angle is placed on an aluminum coupon clad (plated) with aluminum-silicon alloy 4343, and the flux preparation, aged for 1 hour, is painted on the assembly of coupon and angle. The flux load is about 10 g/m². The assembly is heated to about 615° C. and brazed.

### Example 9.2

Example 9.1 is repeated, but the flux preparation is used after aging of 2 hours.

### Example 10

### Brazing with a Si Containing Flux

An aluminum (AA3003) angle is placed on an unclad aluminum coupon (i.e., a coupon which is not coated with a brazing alloy). The flux preparation of Example 7, aged for 1 hour (time span since the first contact between phase II salt and water), is painted on the coupon/angle assembly. The flux load is about 20 g/m². The assembly is heated to about 610° C. and brazed.

### Example 11

### Brazing with a Zinc Flux

An aluminum angle is placed on an aluminum coupon, plated with 4050 brazing alloy. The flux preparation of Example 7, aged for 30 minutes, is painted on the coupon/angle assembly such that the flux load is about 10 g/m², heated to 590° C. and brazed thereby.

1. An aged aqueous flux preparation comprising water and irreversibly dehydrated K₂AlF₅.

2. The flux preparation of claim 1, being aged for at least 12 minutes.

3. The flux preparation of claim 2, being aged for at least 1 hour.

4. The flux preparation of claim 1, comprising equal to or more than 2% by weight of irreversibly dehydrated K₂AlF₅, the total weight of the flux preparation being set to 100% by weight.

5. The flux preparation of claim 1, comprising at least one basic flux selected from the group consisting of KAlF₄, K₂AlF₅, KAlF₅.H₂O, CsAlF₄, Cs₂AlF₅, Cs₃AlF₆, potassium fluorozincate, cesium fluorozincate, potassium fluorostannate, and cesium fluorostannate.

6. The flux preparation of claim 5, wherein the basic flux is comprised in the flux preparation in an amount of from 10 to 50% by weight of the total flux preparation.

7. The flux preparation of claim 1, further comprising at least one additive selected from the group consisting of a binder, a thickener, a brazing alloy, and a brazing alloy precursor.

8. The flux preparation of claim 7, wherein the binder is an organic polymer selected from the group consisting of polyolefins, polyurethanes, resins, phthalates, polyacrylates, polymethacrylates, vinyl resins, epoxy resins, nitrocellulose, polyvinyl acetates, and polyvinyl alcohols.

9. A method for the manufacture of the aged aqueous flux preparation of claim 1 which comprises water and said irreversibly dehydrated K₂AlF₅, said method comprising mixing a liquid carrier and said irreversibly dehydrated K₂AlF₅, wherein said carrier liquid consists of water or comprises water, and wherein a contact time of equal to or more than 12 minutes between said water and said irreversibly dehydrated K₂AlF₅ is provided to allow an aging of the flux preparation.

10. A method for brazing of parts of aluminum or brazing of parts of aluminum alloys to parts of aluminum, aluminum alloys, steel, copper, or titanium, said method comprising coating the aged aqueous flux preparation of claim 1 on at least one of the parts to be brazed; assembling and heating the parts to be brazed until a brazed joint is formed.

11. A flux composition suitable to prepare the aged aqueous flux preparation of claim 1, comprising a basic flux for brazing of parts of aluminum or parts of aluminum alloys to parts of aluminum, aluminum alloys, steel, copper or titanium and equal to or more than 2% by weight of irreversibly dehydrated K₂AlF₅ wherein the basic flux is selected from the group consisting of CsAlF₄, Cs₂AlF₅, Cs₃AlF₆, potassium fluorozincate, cesium fluorozincate, potassium fluorostannate, cesium fluorostannate, and mixtures thereof, and wherein irreversibly dehydrated K₂AlF₅ is excluded from the group of basic fluxes.

12. The flux composition of claim 11, wherein the basic flux is selected from the group consisting of KAlF₄, K₂AlF₅, KAlF₅.H₂O, and mixtures thereof.

13. The flux composition of claim 11, wherein KAlF₄ is comprised in an amount of from 70 to 90% by weight, wherein irreversibly dehydrated K₂AlF₅ is comprised in an amount of from 5 to 30% by weight, and wherein the total content of any form of K₂AlF₅ is from 10 to 50% by weight of the flux composition set to 100% by weight.

14. A method for increasing the viscosity of an aqueous flux preparation comprising a flux for brazing of parts of aluminum or brazing of parts of aluminum alloys to parts of aluminum, aluminum alloys, steel, copper, or titanium, wherein irreversibly dehydrated K₂AlF₅ is present in the aqueous flux preparation, and wherein the aqueous flux preparation is aged for at least 12 minutes.

15. The method of claim 14, wherein the dynamic viscosity is increased by at least 10%.

16. A method for the manufacture of a flux preparation comprising water and irreversibly dehydrated K₂AlF₅, wherein the irreversibly dehydrated K₂AlF₅ is contacted with water or a mixture of water and an organic liquid, and then aged.

17. The method of claim 16, wherein the flux preparation is aged for equal to or more than 4 minutes.

18. The method of claim 16, wherein the flux preparation is aged for equal to or more than 12 minutes.

19. The method of claim 16, wherein the flux preparation comprises a basic flux.

20. The method of claim 9, wherein the carrier liquid further comprises a binder or a thickener.

21. The flux preparation of claim 1, containing no binder and no thickener.
